(19) United States
(12) Patent Application Publication
(10) Pub. No.: US 2014/0014078 A1
(43) Pub. Date: Jan. 16, 2014

(54) ENGINE INCLUDING INTERNAL EGR

(71) Applicants: Charles Dean, Royal Oak, MI (US); Robert D. Straub, Lowell, MI (US)

(72) Inventors: Charles Dean, Royal Oak, MI (US); Robert D. Straub, Lowell, MI (US)

(73) Assignee: GM GLOBAL TECHNOLOGY OPERATIONS LLC, Detroit, MI (US)

(21) Appl. No.: 13/546,568

(22) Filed: Jul. 11, 2012

(51) Int. Cl. F02M 25/07

(52) U.S. Cl. 123/568.13

(57) ABSTRACT

An engine assembly includes an engine structure and an exhaust gas recirculation control valve supported on the engine structure. The engine structure defines a cylinder bore and intake and exhaust ports in communication with the cylinder bore. An internal exhaust gas recirculation passage is defined in the engine structure and extends from the exhaust port to the intake port and may overlie a central region of the cylinder bore. The exhaust gas recirculation control valve is at least partially located within the internal exhaust gas recirculation passage and is displaceable between an open position and a closed position. The open position allows exhaust gas flow from the exhaust port to the intake port through the internal exhaust gas recirculation passage and the closed position obstructs exhaust gas flow from the exhaust port to the intake port through the internal exhaust gas recirculation passage.

### FIELD

The present disclosure relates to engine exhaust gas recirculation systems.

### BACKGROUND

This section provides background information related to the present disclosure which is not necessarily prior art.

Internal combustion engines may include exhaust gas recirculation systems to provide exhaust gas to the combustion chambers for a subsequent combustion event. In order to provide exhaust gas flow to the combustion chambers a flow path from the exhaust system to the intake system is typically included, resulting in heat loss and additional components requiring packaging space and assembly time.

### SUMMARY

An engine cylinder head may include a cylinder head structure defining intake and exhaust ports for communication with a cylinder bore and an internal exhaust gas recirculation passage. The internal exhaust gas recirculation passage may extend from the exhaust port to the intake port in a direction from an exhaust side of the cylinder head to an intake side of the cylinder head and may be configured to overlie a central region of the cylinder bore.

An engine assembly may include an engine structure and an exhaust gas recirculation control valve supported on the engine structure. The engine structure may define a cylinder bore and intake and exhaust ports in communication with the cylinder bore. An internal exhaust gas recirculation passage may be defined in the engine structure and may extend from the exhaust port to the intake port and may overlie a central region of the cylinder bore. The exhaust gas recirculation control valve may be at least partially located within the internal exhaust gas recirculation passage and may be displaceable between an open position and a closed position. The open position may allow exhaust gas flow from the exhaust port to the intake port through the internal exhaust gas recirculation passage and the closed position may obstruct exhaust gas flow from the exhaust port to the intake port through the internal exhaust gas recirculation passage.

In another arrangement, an engine assembly may include an engine block defining a cylinder bore, a cylinder head coupled to the engine block, an exhaust gas recirculation control valve supported on the cylinder head, an intake system, an exhaust system and a backpressure control valve. The cylinder head may define intake and exhaust ports in communication with the cylinder bore and an internal exhaust gas recirculation passage extending from the exhaust port to the intake port and overlying a central region of the cylinder bore. The exhaust gas recirculation control valve may be at least partially located within the internal exhaust gas recirculation passage and may be displaceable between an open position and a closed position. The open position may allow exhaust gas flow from the exhaust port to the intake port through the internal exhaust gas recirculation passage and the closed position may obstruct exhaust gas flow from the exhaust port to the intake port through the internal exhaust gas recirculation passage. The intake system may be in communication with the intake port and the exhaust system may be in communication with the exhaust port. The backpressure control valve may be located in the exhaust system and may be configured to adjust a pressure differential between the intake and exhaust ports.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only and are not intended to limit the scope of the present disclosure in any way.

FIG. 1 is a schematic illustration of an engine assembly according to the present disclosure;

FIG. 2 is a schematic section view of the engine assembly from FIG. 1 with an internal EGR valve in a closed position according to the present disclosure;

FIG. 3 is a schematic section view of the engine assembly from FIG. 1 with the internal EGR valve in an open position; and

FIG. 4 is a schematic section view of the cylinder head from the engine assembly shown in FIGS. 2 and 3.

Corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. As used herein, the term “module” refers to an application specific integrated circuit (ASIC), an electronic circuit, and/or a processor (shared, dedicated, or group) and memory that execute one or more software or firmware programs.

When an element or layer is referred to as being “on,” “engaged to,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

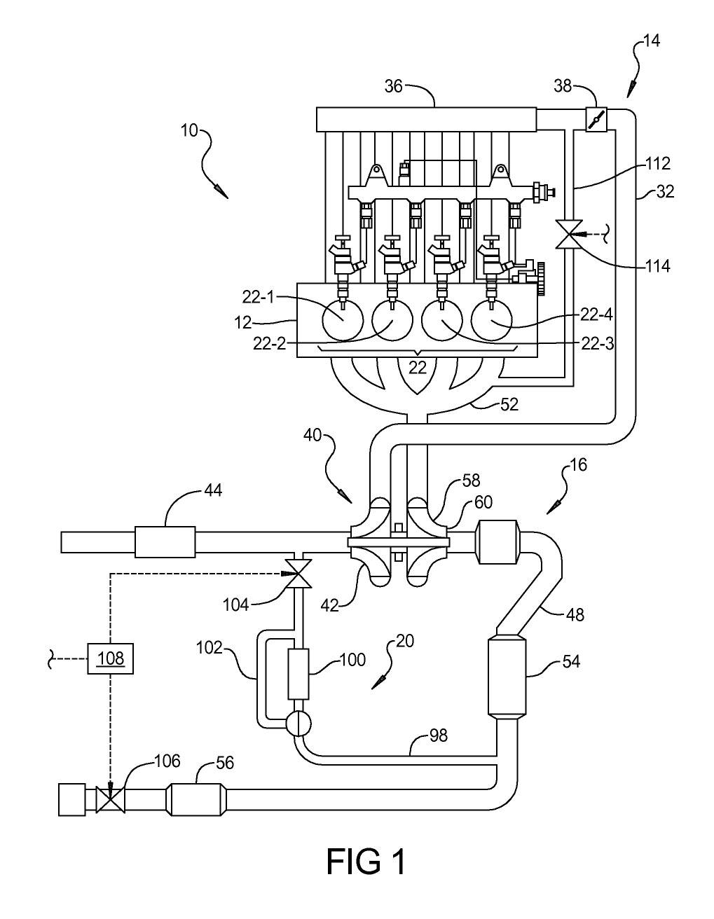

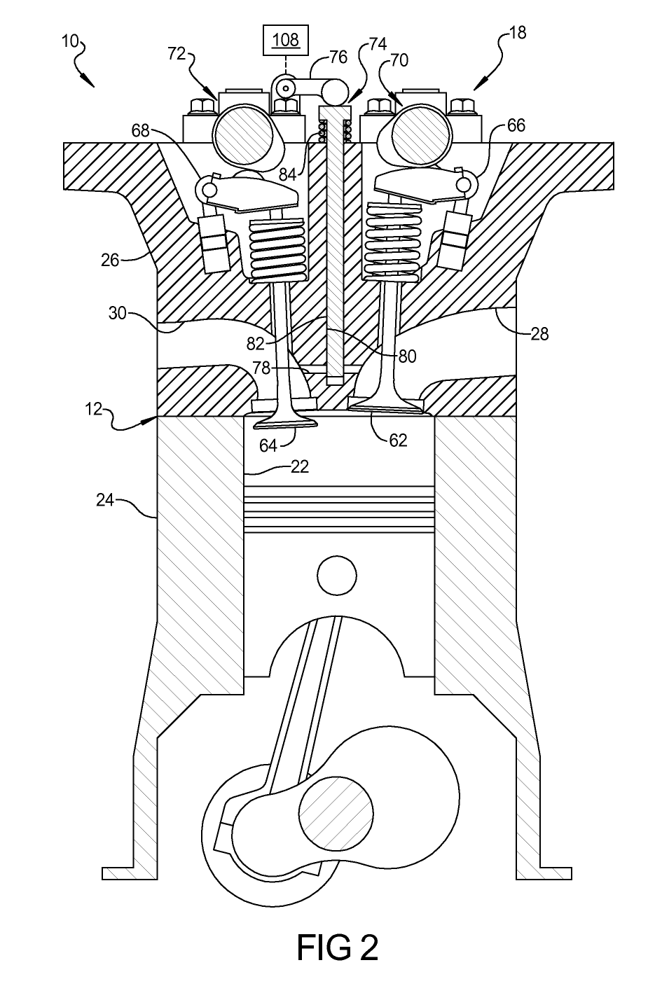

With reference to FIGS. 1 and 2, an engine assembly 10 may include an engine structure 12, an intake system 14, an exhaust system 16, a valvetrain assembly 18 and an exhaust gas recirculation (EGR) assembly 20. The engine structure 12 may define cylinder bores 22 forming combustion chambers. The engine structure 12 may include an engine block 24 defining the cylinder bores 22 and a cylinder head 26 coupled to the engine block 24 and defining intake and exhaust ports 28, 30 in communication with the combustion chambers.

An inline engine configuration having four cylinders (22-1, 22-2, 22-3, 22-4) is schematically shown in FIG. 1 for illustration purposes only with a single cylinder illustrated in the section view shown in FIG. 2 for simplicity. It is understood that the features discussed relative to the cylinder shown in FIG. 2 apply equally to the remaining cylinders of the engine assembly 10. Additionally, it is understood that the present teachings apply to any number of piston-cylinder arrangements and a variety of reciprocating engine configurations including, but not limited to, V-engines, inline engines, and horizontally opposed engines, as well as both overhead cam and cam-in-block configurations.

The intake system 14 may include an intake conduit 32, an intake manifold 36 coupled to the cylinder head 26 and in communication with the intake conduit 32, a throttle valve 38 in the intake conduit 32 and controlling air flow to intake port 28 through the intake manifold 36, a turbocharger 40 including an intake side 42 (compressor) located in the intake conduit 32 and an air cleaner 44 located in the intake conduit 32. The intake conduit 32 may define an air inlet into the intake system 14 and the turbocharger 40 may be in communication with the intake ports 28 via the intake manifold 36. While a single turbocharger 40 is illustrated, it is understood that the present disclosure applies equally to arrangements including multiple turbochargers.

The exhaust system 16 may include an exhaust conduit 48, an exhaust manifold 52 coupled to the cylinder head 26 and in communication with the exhaust conduit 48, and a diesel particulate filter (DPF) 54 and a selective catalytic reduction (SCR) catalyst 56 located in the exhaust conduit 48. While illustrated as including an individual DPF 54 and an individual SCR catalyst 56, it is understood that the present disclosure is not limited to such arrangements. The DPF 54 may alternatively be included in a combined DPF/SCR catalyst. Further, the SCR catalyst 56 may alternatively be located upstream of the DPF 54 or an additional SCR catalyst (not shown) may be included upstream of the DPF 54. The exhaust side 58 (turbine) of the turbocharger 40 may be located in the exhaust conduit 48 and may include a turbine wheel in communication with and driven by exhaust gas flowing through the exhaust conduit 48. The exhaust side 58 of the turbocharger 40 may include a variable exhaust gas outlet 60 that controls an exhaust gas flow restriction through the turbocharger 40. The variable exhaust gas outlet 60 may be in the form of a variable nozzle.

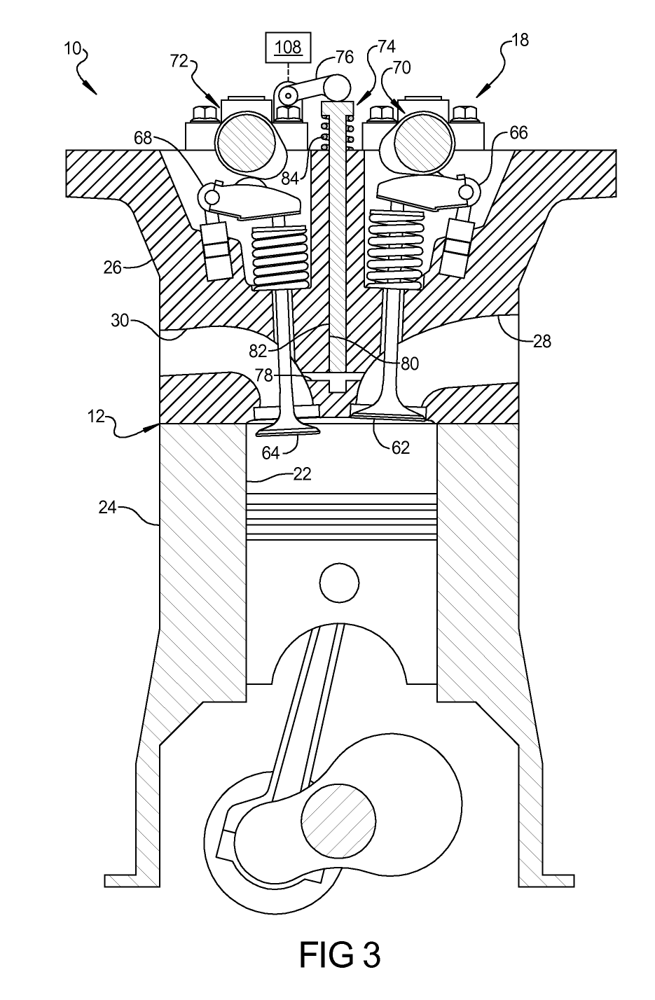

As seen in FIGS. 2 and 3, the valvetrain assembly 18 may include intake valves 62 located in the intake ports 28, exhaust valves 64 located in the exhaust ports 30, intake valve lift mechanisms 66 supported on the cylinder head 26 and engaged with the intake valves 62, exhaust valve lift mechanisms 68 supported on the cylinder head 26 and engaged with the exhaust valves 64, an intake camshaft 70 supported for rotation on the cylinder head 26 and engaged with the intake valve lift mechanisms 66 and an exhaust camshaft 72 supported for rotation on the cylinder head 26 and engaged with the exhaust valve lift mechanisms 68.

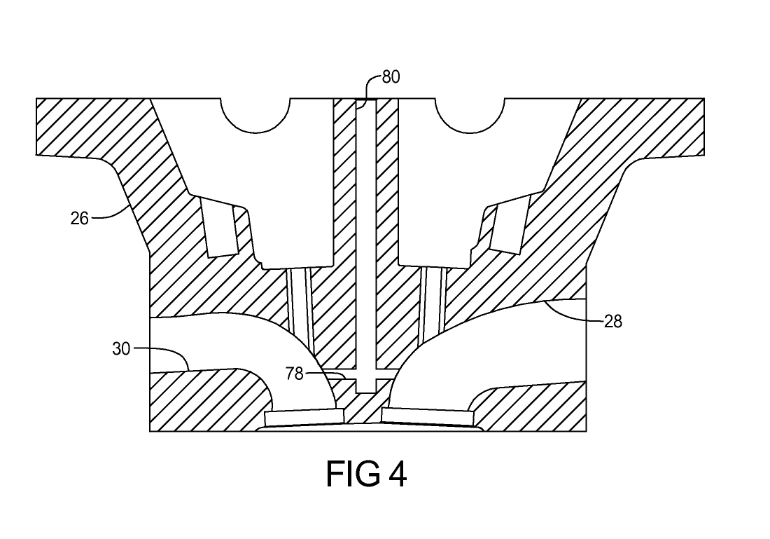

The exhaust gas recirculation assembly 20 may include an EGR control valve 74 and an actuation mechanism 76. With additional reference to FIG. 4, the cylinder head 26 may define an internal exhaust gas recirculation passage 78 extending from the exhaust port 30 to the intake port 28 and overlying a central region of the cylinder bore 22. The internal exhaust gas recirculation passage 78 may extend from an exhaust side to an intake side of the cylinder head 26 and may be completely defined within the cylinder head 26 within an outer perimeter of the cylinder bore 22. More specifically, the internal exhaust gas recirculation passage 78 may be defined within the cylinder head 26 at a location radially between the intake and exhaust ports 28, 30. The minimal length of the internal exhaust gas recirculation passage 78 defined within the cylinder head 26 may generally minimize heat loss from the exhaust gas being provided for a subsequent combustion event. The intake or exhaust port 28, 30 may form an entry location for a machining tool to create the internal exhaust gas recirculation passage 78.

The cylinder head 26 may additionally define a bore 80 intersecting the internal exhaust gas recirculation passage 78. The EGR control valve 74 may be supported on the cylinder head 26 and may include an actuation piston 82 and a biasing member 84. The actuation piston 82 may be located in the bore 80 and engaged with the actuation mechanism 76 for displacement between a closed position (FIG. 2) and an open position (FIG. 3). The biasing member 84 may take a variety of forms including, but not limited to, a compression spring and may bias the actuation piston 82 to the open position. The actuation mechanism 76 may take a variety of forms including, but not limited to, an electro-mechanical arrangement including the rocker arm illustrated in FIGS. 2 and 3. Alternatively, the actuation mechanism 76 may be in the form of a hydraulically-actuated valve.

The exhaust gas recirculation assembly 20 may additionally include an EGR line 98, an EGR cooler 100 and cooler bypass 102 located in the EGR line 98, an EGR control valve 104 and a backpressure control valve 106. The EGR line 98 may extend from the exhaust conduit 48 at a location between the turbocharger 40 and an outlet of the exhaust conduit 48 to the intake system 14 to provide communication between the intake and exhaust systems 14, 16.

In the non-limiting example shown in FIG. 1, the EGR control valve 104 may be located at the outlet of the EGR line 98 and may control exhaust gas recirculation flow to the intake system 14 from the EGR line 98. The backpressure control valve 106 may be located in the exhaust conduit 48 at a location between the EGR line 98 and an outlet of the exhaust conduit 48. In the non-limiting example shown in FIG. 1, the backpressure control valve 106 is located at the outlet of the exhaust conduit 48. The DPF 54 may be located in the exhaust conduit 48 at a location between the exhaust side 58 of the turbocharger 40 and the backpressure control valve 106. The arrangement discussed above provides an internal EGR system in combination with a low pressure EGR system.

More specifically, the engine assembly 10 may additionally include a control module 108 in communication with the actuation mechanism 76, the EGR control valve 104 and the backpressure control valve 106. The backpressure control valve 106 may be used to control the pressure differential between the intake system 14 and the exhaust system 16 for both the internal EGR system and the low pressure EGR system to adjust recirculation of exhaust gas in the engine assembly 10. The EGR control valves 74, 104 may be adjusted by the control module 108 to provide a desired amount of exhaust gas recirculation during engine operation. The throttle valve 38 and the variable exhaust gas outlet 60 of the turbocharger 40 may also be used to control the pressure differential between the intake system 14 and the exhaust system 16 to further adjust the amount of exhaust gas recirculated in the engine assembly 10. In some arrangements, the exhaust gas recirculation assembly 20 may additionally include a bypass passage 112 and a bypass valve 114 located in the bypass passage 112 and in communication with the control module 108. The bypass passage 112 may extend from the exhaust manifold 52 to a region of the intake conduit 32 located between the intake throttle valve 38 and the intake manifold 36 to provide further control of exhaust gas recirculation.

The internal EGR system may be used as the high pressure EGR system, eliminating the typical high pressure EGR lines and cooler, eliminating the potential for high pressure EGR cooler fouling.

What is claimed is:

1. An engine cylinder head comprising:
a cylinder head structure defining intake and exhaust ports for communication with a cylinder bore; and
an internal exhaust gas recirculation passage defined in the cylinder head structure and extending from the exhaust port to the intake port in a direction from an exhaust side of the cylinder head to an intake side of the cylinder head and configured to overlie a central region of the cylinder bore.

2. The engine cylinder head of claim 1, wherein the internal exhaust gas recirculation passage is completely defined within the cylinder head structure.

3. The engine cylinder head of claim 2, wherein the internal exhaust gas recirculation passage is defined within the cylinder head at a location radially between the intake and exhaust ports.

4. The engine cylinder head of claim 1, wherein the internal exhaust gas recirculation passage is configured to be defined within an outer perimeter of the cylinder bore.

5. An engine assembly comprising:
an engine structure defining a cylinder bore and intake and exhaust ports in communication with the cylinder bore;
an internal exhaust gas recirculation passage defined in the engine structure and extending from the exhaust port to the intake port overlying a central region of the cylinder bore; and
an exhaust gas recirculation control valve supported on the engine structure, at least partially located within the internal exhaust gas recirculation passage and displaceable between an open position and a closed position, the open position allowing exhaust gas flow from the exhaust port to the intake port through the internal exhaust gas recirculation passage and the closed position obstructing exhaust gas flow from the exhaust port to the intake port through the internal exhaust gas recirculation passage.

6. The engine assembly of claim 5, wherein the engine structure includes a cylinder head defining the internal exhaust gas recirculation passage in a direction from an exhaust side of the cylinder head to an intake side of the cylinder head.

7. The engine assembly of claim 6, wherein the exhaust gas recirculation control valve includes an actuation piston located in a bore defined in the cylinder head and intersecting the internal exhaust gas recirculation passage.

8. The engine assembly of claim 7, further comprising an actuation mechanism engaged with the actuation piston and configured to displace the actuation piston between the open and closed positions.

9. The engine assembly of claim 8, further comprising a biasing member engaged with the actuation piston and biasing the actuation piston to the open position.

10. The engine assembly of claim 6, wherein the internal exhaust gas recirculation passage is completely defined within the cylinder head.

11. The engine assembly of claim 10, wherein the internal exhaust gas recirculation passage is defined within the cylinder head at a location radially between the intake and exhaust ports.

12. The engine assembly of claim 5, wherein the internal exhaust gas recirculation passage is defined within an outer perimeter of the cylinder bore.

13. The engine assembly of claim 5, further comprising a backpressure control valve located in an exhaust system of the engine assembly in communication with the exhaust port and being configured to adjust a pressure differential between the intake and exhaust ports.

14. The engine assembly of claim 13, wherein the backpressure control valve is configured to control an amount of exhaust gas recirculation through the internal exhaust gas recirculation passage when the exhaust gas recirculation control valve is in the open position.

15. The engine assembly of claim 13, wherein the exhaust system includes a diesel particulate filter and the backpressure control valve is located downstream of the diesel particulate filter.

16. An engine assembly comprising:
an engine block defining a cylinder bore;
a cylinder head coupled to the engine block and defining intake and exhaust ports in communication with the cylinder bore and an internal exhaust gas recirculation passage extending from the exhaust port to the intake port and overlying a central region of the cylinder bore;
an exhaust gas recirculation control valve supported on the cylinder head, at least partially located within the internal exhaust gas recirculation passage and displaceable between an open position and a closed position, the open position allowing exhaust gas flow from the exhaust port to the intake port through the internal exhaust gas recirculation passage and the closed position obstructing exhaust gas flow from the exhaust port to the intake port through the internal exhaust gas recirculation passage;
an intake system in communication with the intake port;
an exhaust system in communication with the exhaust port; and
a backpressure control valve located in the exhaust system and configured to adjust a pressure differential between the intake and exhaust ports.

17. The engine assembly of claim 16, wherein the backpressure control valve is configured to control an amount of exhaust gas recirculation through the internal exhaust gas recirculation passage when the exhaust gas recirculation control valve is in the open position.

18. The engine assembly of claim 17, wherein the exhaust system includes a diesel particulate filter and the backpressure control valve is located downstream of the diesel particulate filter.

19. The engine assembly of claim 16, wherein the internal exhaust gas recirculation passage is completely defined within the cylinder head.

20. The engine assembly of claim 19, wherein the internal exhaust gas recirculation passage is defined completely within an outer perimeter of the cylinder bore.
